(19) United States
(12) Patent Application Publication
(10) Pub. No.: US 2015/0265487 A1
(43) Pub. Date: Sep. 24, 2015

(54) Neck pain and headache relief device

(71) Applicants: Yevgeny Shirokobrod, Westminster, MD (US); Corey Adam Fleischer, Westminster, MD (US)

(72) Inventors: Yevgeny Shirokobrod, Westminster, MD (US); Corey Adam Fleischer, Westminster, MD (US)

(21) Appl. No.: 14/544,273

(22) Filed: Dec. 16, 2014

Related U.S. Application Data
(60) Provisional application No. 62/122,819, filed on Oct. 30, 2014.
(60) Provisional application No. 61/963,958, filed on Dec. 19, 2013.

(51) Int. Cl. A61H 1/02; A61H 1/00; A47C 7/42

(52) U.S. Cl. CPC A61H 1/0218; A47C 7/42; A61H 1/008

(57) ABSTRACT

A device, which can primarily be described as an arc shaped item designed to contact the back of a person's neck in certain locations while the user lays in a horizontal position, so as to relieve compression by passively creating tension along the user's cervical system, thereby helping to alleviate or prevent neck pain and headaches which are caused by cervical (neck) muscle tightness and joint irritation, and its methods of use.

This application is entitled to, and claims the benefit of, priority from U.S. Provisional Application Ser. No. 61/963,958, filed Dec. 19, 2013 and U.S. Provisional Application Ser. No. 62/122,819, filed Oct. 30, 2014, each of which is incorporated herein by reference.

### FIELD AND BACKGROUND OF THE INVENTION

1. Field of the Invention

The present invention relates in general to treatment of neck pain and headaches and in particular to a new and useful device which helps relieve neck pain and headaches caused by cervical (neck) muscle tightness and joint irritation.

2. Background Information

Headaches and back pain are common. Back pain is among the most common reasons for visits to primary care physicians. Often the causes relate to muscle tightness or joint irritation or to poor seating posture, often attributable to ergonomically deficient chairs. Treatments include medication, physical therapy and in severe cases surgery, as well as muscle strengthening and posture correction designed to reduce the causes of such headaches and back pain.

### SUMMARY OF THE INVENTION

The invention described and claimed herein comprises a novel device, whose principal feature is its arc shape designed to contact the back of a person's neck in certain locations while the user lays in a horizontal position, so as to relieve compression by passively creating tension along the user's cervical system, thereby helping to alleviate or prevent neck pain and headaches that are caused by cervical (neck) muscle tightness and joint irritation, with the advantages of reducing the need for medication or surgery, both of which pose the risk of adverse side effects.

In a second embodiment, the device may be used to improve seated posture and thereby alleviate symptoms associated with poor posture or ergonomically deficient chairs. Prior art devices focus on lumbar support, an approach which proves to be less than useful as it does not adequately discourage individuals from slumping as shown in FIG. 4A. When using the invention over the thoracic spine region, it physically encourages the user to sit in an upright position and helps align the spine to a healthy, natural position, as shown in FIG. 4B.

These and other objects, features and advantages which will be apparent from the disclosure which follows, are achieved, in accordance with the invention, by providing a novel device comprising an arc shaped segment designed to contact the back of a person's neck in certain locations while the user lays in a horizontal position, so as to relieve compression by passively creating tension along the user's cervical system, thereby helping to alleviate or prevent neck pain and headaches which are caused by cervical (neck) muscle tightness and joint irritation.

The various features of novelty which characterize the invention are pointed out with particularity in the claims annexed to and forming a part of this disclosure. For a better understanding of the invention, its advantages and objects, reference is made to the accompanying drawings and descriptive matter in which a preferred embodiment of the invention is illustrated.

### BRIEF DESCRIPTION OF THE DRAWINGS

The foregoing and still other objects of this invention will become apparent, along with various advantages and features of novelty residing in the present embodiments, from study of the following drawings, in which:

FIG. 1 is an isometric view of the invention.

FIGS. 2A, 2B and 2C are cross-section views of embodiments of the invention.

FIG. 3 is a view of the invention in use in one embodiment.

FIG. 4 is a view of the invention in use in a second embodiment (4B) in contrast to prior art (4A).

### DESCRIPTION OF THE PREFERRED EMBODIMENT

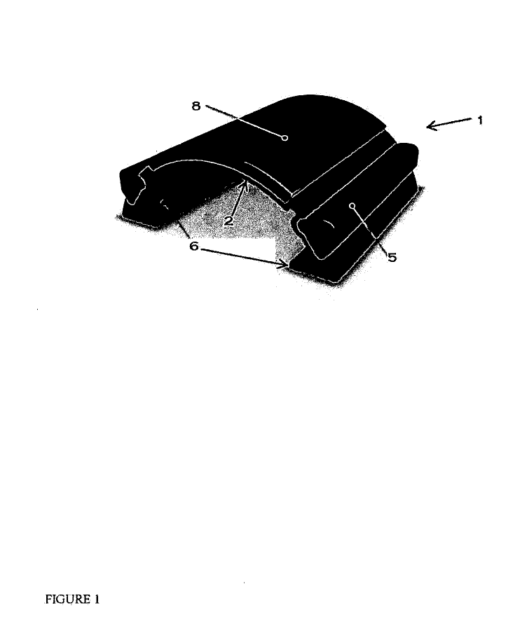

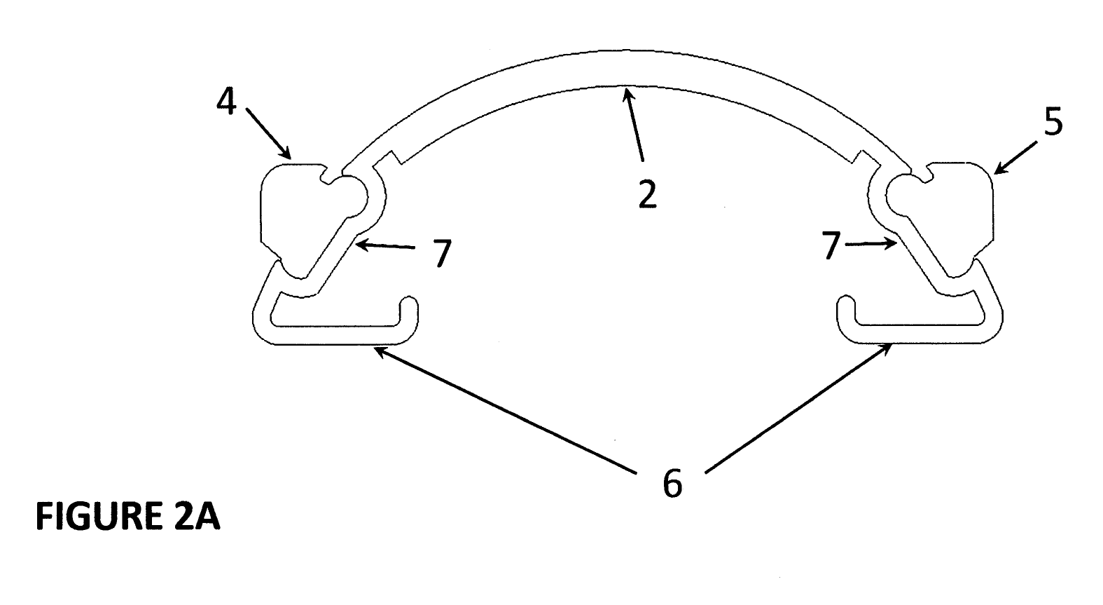

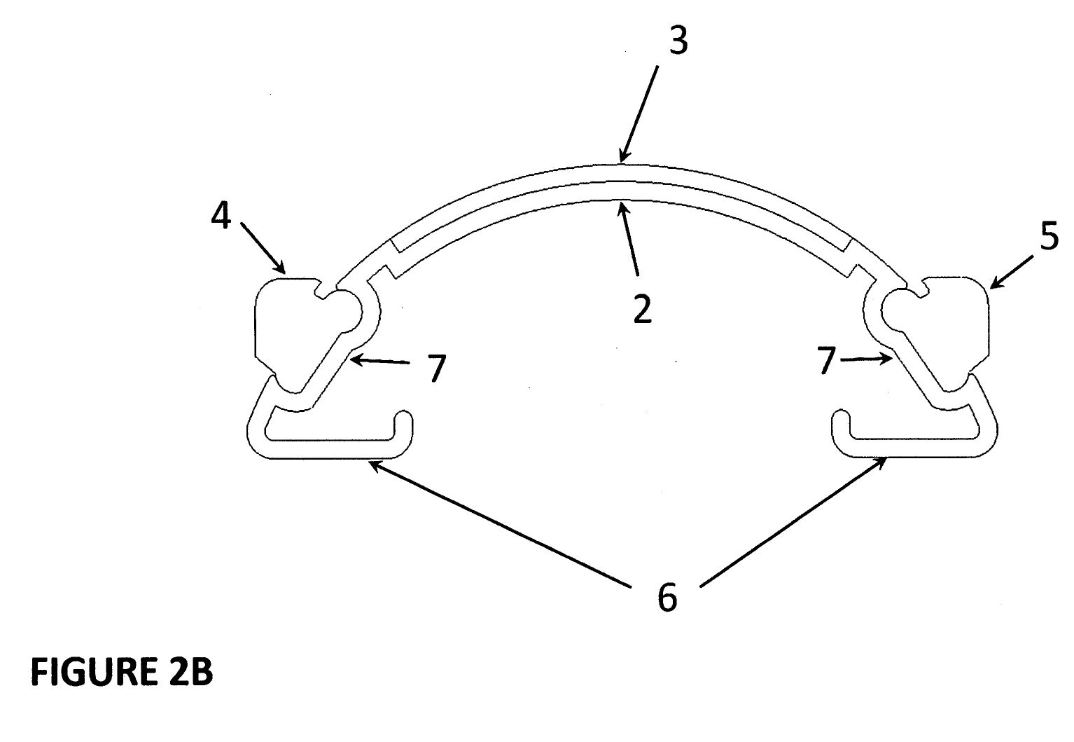

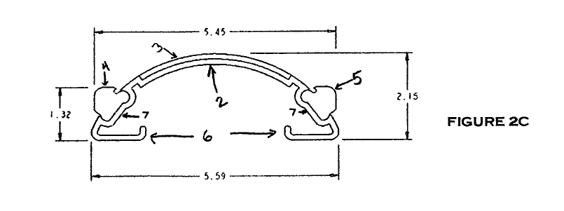

The invention described and claimed herein comprises a novel device, which can primarily be described as an arc shaped manufacture (1), shown in overview in FIG. 1 and in cross-section in FIGS. 2A, 2B and 2C, designed to contact the back of a person's neck in certain locations while the user lays in a horizontal position, so as to relieve compression by passively creating tension along the user's cervical system, thereby helping to alleviate or prevent neck pain and headaches which are caused by cervical (neck) muscle tightness and joint irritation.

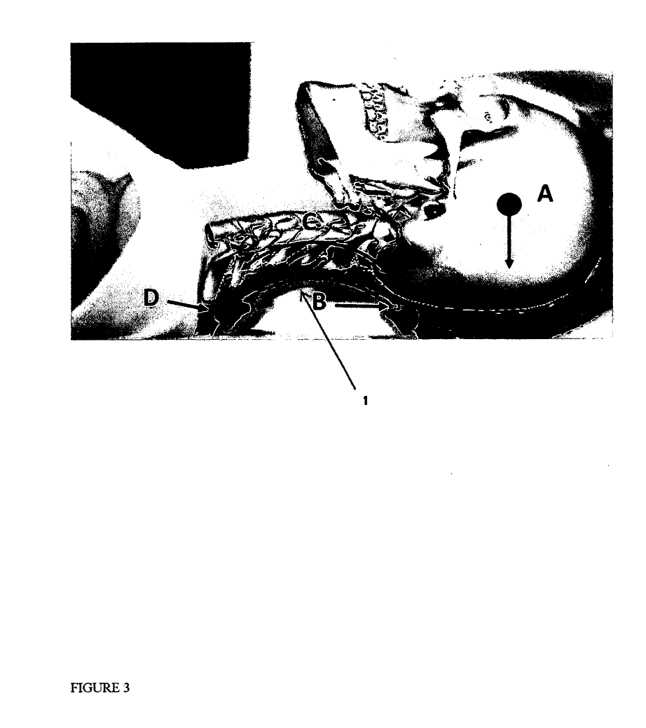

The arc is selected so that, when the user lays down on a surface with their back facing down against the ground and the device is properly positioned underneath the user's neck and against the ground, the user's head is slightly elevated and suspended off the ground, as illustrated in FIG. 3.

In its most basic embodiment, the device comprises a semi-cylindrical arc (2) as shown in FIG. 2A. A preferred embodiment further comprises a neck pad (3) as shown in FIGS. 1 and 2B. A prototype was constructed having a length of 5.59 inches and a height of 2.15″, as shown in FIG. 2C. These dimensions were chosen so as to provide contact with an average adult user's skull, follow the contour of the user's neck and cervical system, and terminate at a point where the top of the user's head is slightly suspended when in use so as to provide the force necessary to decompress the proper segments of the user's spine. Reducing these dimensions by about 15% provides a device suitable for use by a smaller adult or child. Referring to FIG. 3, the device follows the contour of the user's neck and cervical system along line from D to B, and the user's head provides a downward force along line A. The weight of the user's head is the driving force that creates the tension throughout the cervical system as shown along line C. When the user lies down on the device with their head suspended, a reaction force at the base of the user's skull is provided by the device. By keeping the user's head slightly suspended, reaction force at the base of the skull creates tension along the cervical system. This tension/decompression is the mechanism to which reduces and/or eliminates headaches caused by cervical compression and/or relieves joint irritation created from joint compression.

In a preferred embodiment, the device further comprises contact regions: a distal contact region (4) designed to contact the base of a user's skull and a proximal contact region (5) designed to contact a user's upper back to stabilize the placement of the device and ensure that it does not slide out of position during use. Stability is further provided by flanges (6), designed to provide a stable base when the device is placed on a flat surface.

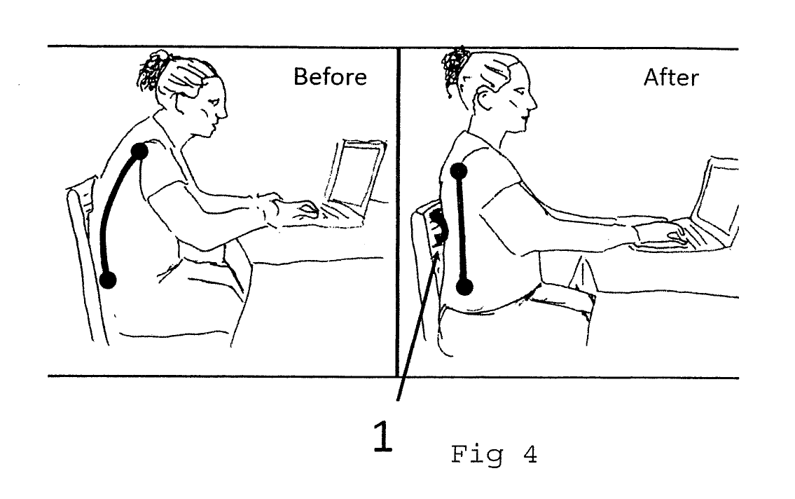

An alternative embodiment, shown in FIG. 4 is useful for improving posture by placing the device between a chair back and the thoracic portion of a user's back. When so used, the device (1) helps to discourage slouching (illustrated in FIG. 4A) by encouraging a seated user to maintain spinal lordosis, as illustrated in FIG. 4B.

The device may be made by creating an arced, rigid structure designed to follow the contour of a user's neck and cervical system. In a preferred embodiment, the structure is of semi-cylindrical arced shape made of a rigid polymer structure (for example, PVC, Polypropylene or ABS). The cross-section is preferably uniform, which allows it to be constructed by common plastic extrusion processes typically used for extruding thermoplastic profiles and known to those skilled in the art. The rigid structure allows for supporting a user's neck or upper back if the user is using the arc in its laying down or sitting upright positions, respectively.

A preferred embodiment also includes recesses (7) in a proximal portion (designed to contact a user's upper back) and a distal portion (designed to contact a user's skull) of the device, suitable for receiving contact inserts, which are preferably made of rubber or a similar material. Such contacts are useful in maintaining the device in a proper position when in use. They may also be placed so as to contact muscle release points. The inserts preferably have a uniform cross section as to allow them to be manufactured by extrusion, but could also be provided as discrete contact points. While suitable materials include any type of elastomer included but not limited to natural rubber, silicone, santoprene, a preferred material is rubber, preferably having a soft durometer between 10 and 60 Shore A.

Suitable dimensions for an average adult user would be an overall height of approximately 2.15 inches and length on the order of 5.59 inches. The width of the device is chosen as a matter of portability, economics and other factors which do not affect the operation of the invention (provided that the width is sufficient to support the user's neck or back, depending on the application); a width of on the order of 5 inches would be suitable.

In a preferred embodiment, the central portion of the device may also be covered by a material designed to provide a more comfortable contact region. The pad may be a discrete component, as shown in FIG. 2C (3) or may be combined with one of the contact points as shown in FIG. 1 (8) or combined with both contact points. A cellular/foam pad is a suitable material.

The invention may be used by placing it between under a user's neck when the user is in a horizontal, face up, position as illustrated in FIG. 3. In this position, the primary objective is to relieve muscle tension and/or spinal compression, thereby alleviating neck pain, headache or other discomfort.

The invention may, alternatively, be used by placing it between the thoracic portion of a user's back and a chair back when the user is seated, as illustrated in FIG. 4. In this position, the primary objective is to encourage proper seated posture, thereby alleviating pain and discomfort associated with improper posture. The characteristics and dimensions described above are also suitable for this use.

Thus, there has been described a novel device which can primarily be described as an arc shaped manufacture designed to contact the back of a person's neck in certain locations while the user lays in a horizontal position, so as to relieve compression by passively creating tension along the user's cervical system, thereby helping to alleviate or prevent neck pain and headaches which are caused by cervical (neck) muscle tightness and joint irritation that has a number of novel features, and a manner of making and using the invention.

While a specific embodiment of the invention has been shown and described in detail to illustrate the application of the principles of the invention, it will be understood that the invention may be embodied otherwise without departing from such principles and that various modifications, alternate constructions, and equivalents will occur to those skilled in the art given the benefit of this disclosure. Thus, the invention is not limited to the specific embodiment described herein, but is defined by the appended claims.

What is claimed is:

1. A manufacture for relief of pain/discomfort resulting from spinal compression, comprised of an arc sized so as to contact the base of a user's skull, follow the contour of the user's neck and cervical system, with a termination point prior to the top of the user's head.

2. A manufacture as in claim 1, wherein the termination point is chosen such that, in use, the user's head will be slightly suspended so as to provide a force necessary to decompress segments of the user's spine.

3. A manufacture as in claim 1, wherein said ac-shaped device has a height of approximately 2.15 inches and a length on the order of 5.59 inches.

4. A manufacture as in claim 1, further comprising receptacles suitable for receiving contact inserts.

5. A manufacture as in claim 1, further comprising an insert comprised of an elastomer.

6. A manufacture as in claim 4 wherein said elastomer is natural rubber, silicone or santoprene.

7. A manufacture as in claim 5 wherein said elastomer is rubber having a soft durometer between 10 and 60 Shore A.

8. A manufacture as in claim 1, further comprising a padded central portion.

9. A manufacture as in claim 1, further comprising a flange attached to an end of said arc.

10. A process for relieving spinal compression and its resulting discomfort, comprising:
providing a manufacture comprising an arc shaped device sized so as to contact the base of a user's skull, follow the contour of the user's neck and cervical system, with a termination point prior to the top of the user's head; and
positioning the device in a comfortable position beneath the neck of a user in a face-up horizontal position, supporting the user's neck.

11. A process for improving seated posture, comprising:
providing a manufacture comprising an arc shaped device sized so as to contact the base of a user's skull, follow the contour of the user's neck and cervical system, with a termination point prior to the top of the user's head; and
placing the device between a chair back and the thoracic portion of a user's back.
